(19) United States
(12) Patent Application Publication
(10) Pub. No.: US 2011/0126924 A1
(43) Pub. Date: Jun. 2, 2011

(54) SUCTION CHECK VALVE OF AIR-CON COMPRESSOR OF VEHICLE

(75) Inventor: Hyunbae Goh, Suwon-si (KR)

(73) Assignees: Hyundai Motor Company, Seoul (KR); Kia Motors Corporation, Seoul (KR)

(21) Appl. No.: 12/880,467

(22) Filed: Sep. 13, 2010

(30) Foreign Application Priority Data
Dec. 2, 2009 (KR) 10-2009-0118697

(51) Int. Cl. F16K 15/00

(52) U.S. Cl. 137/540

(57) ABSTRACT

A suction check valve of an air-con compressor of a vehicle, may include a valve housing fixed in an intake port of the air-con compressor and having at least a housing hole, a valve core elastically supported upwards by an elastic member in the valve housing to reciprocate in the longitudinal direction of the valve housing and having at least a core groove formed along outer circumference thereof, and a valve cap connected to an upper end of the valve housing to prevent the valve core from separating from the valve housing and having a cap hole connected the intake port with the valve housing.

### CROSS-REFERENCE TO RELATED APPLICATIONS

The present application claims priority to Korean Patent Application Number 10-2009-0118697 filed Dec. 2, 2009, the entire contents of which application is incorporated herein for all purposes by this reference.

### BACKGROUND OF THE INVENTION

1. Field of the Invention

The present invention relates to suction check valve of air-con compressor of vehicle which has an improved structure for low-pressure coolant to rapidly and smoothly flow outside through housing holes, when the compressor starts to operate.

2. Description of Related Art

In general, main components of air-conditioning system in vehicles are an expansion valve, an evaporator, a compressor, and a condenser etc.

The expansion valve receives and throttles liquid-state coolant at high temperature and pressure into liquid-state coolant at low temperature and pressure and then sends it to the evaporator, and the evaporator generates a cold wind, using heat of vaporization that is generated by evaporating the coolant at low temperature and pressure.

The compressor, which is driven by the engine, compresses gas-state coolant at low temperature and pressure discharged from the evaporator into gas-state coolant at high temperature and pressure and sends it to the condenser, and the condenser cools and condensates the coolant sent from the compressor into liquid-state coolant at high temperature and pressure.

A compressor 1, as shown in FIG. 1, has an intake port 1a for sucking gas-state coolant at lower temperature and pressure discharged from the evaporator, and intake port 1a is equipped with a suction check valve 10.

Suction check valve 10, as shown in FIGS. 2 and 3, includes a valve housing 11 fixed in intake port 1a, a valve core 13 elastically supported by a valve spring 12 in valve housing 11 to reciprocate in the longitudinal direction of valve housing 11, and a valve cap 14 connected to the upper end of valve housing 11 to prevent valve core 13 from separating from valve housing 11 and having a cap hole 14a connecting intake port 1a with valve housing 11.

Valve housing 11 is formed in a cylinder 11a with a bottom 11b and a plurality of housing holes 11c is circumferentially formed at regular intervals in cylinder 11a.

Housing holes 11c are composed of three holes having the same area and spaced at 120° from each other, as shown in FIG. 4.

In suction check valve 10 having the above configuration, as valve core 13 is moved down against the force of valve spring 12 by pressure of coolant discharged from the evaporator, cap hole 14a is connected with housing holes 11c, such that the coolant flows into a suction chamber of compressor 1.

Suction valve 10 of the related art described above, however, has a problem that noise is generated by vibration of valve core 13, when compressor 1 starts to operate.

That is, coolant at low initial pressure flows inside through cap holes 14a, when compressor 1 converts from the OFF-state into the ON-state.

Accordingly, although valve core 13 moves down against the force of valve spring 12, the displacement is very small to the low pressure of the coolant.

Therefore, valve core 13 is vibrated by confliction of the low pressure of the coolant and the force of valve spring 12, and noise is caused by a difference in pressure when the coolant flows outside through a small gap between the lower ends of cap hole 14a and the upper end of valve core 13. As a result, the noise travels to the inside of a vehicle and gives passengers an unpleasant feeling.

Further, since the cross-sectional areas of housing holes 11c are the same in suction check valve 10 of the related art, it takes long time for low-pressure coolant flows out through housing holes 11c when compressor 1 starts, such that the noise generated by vibration of valve core 13 continues for a predetermined time.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to prevent vibration of a valve core and noise, by providing a suction check valve of an air-con compressor having an improved structure for low-pressure coolant to rapidly and smoothly flow outside through housing holes, when the compressor starts to operate.

In an aspect of the present invention, the suction check valve of an air-con compressor of a vehicle, may include a valve housing fixed in an intake port of the air-con compressor and having at least a housing hole, a valve core elastically supported upwards by an elastic member in the valve housing to reciprocate in the longitudinal direction of the valve housing and having at least a core groove formed along outer circumference thereof, and a valve cap connected to an upper end of the valve housing to prevent the valve core from separating from the valve housing and having a cap hole connected the intake port with the valve housing.

Any one of the at least a core groove may be always fluid-communicated with any one of the at least a housing hole.

The valve housing may include a cylinder portion to slidably receive the valve core therein and a bottom portion to support the elastic member, wherein the at least a housing hole is formed to the cylinder portion along a longitudinal direction thereof, and at least one of the housing holes has a cross-sectional area different from the other housing holes.

The at least a housing hole may be formed approximately at 120° from each other along the circumference of the cylinder portion.

At least one of the housing holes may be larger in cross-sectional area than other housing holes, wherein the at least one of the housing holes that is larger in cross-sectional area than the other housing holes is formed at upper portion of the cylinder portion.

The at least one of the housing holes that is larger in cross-sectional area than the other housing holes and is formed at upper portion of the cylinder portion, may be connected to a housing slot extending to the bottom portion of the valve housing along the cylinder portion.

A circumferential length of the at least one of the housing holes that is larger in cross-sectional area than the other housing holes and is formed at the upper portion of the cylinder portion, may be larger than a circumferential length of the housing slot.

The at least a core groove may be formed on the outer circumference of the valve core to connect the top with the bottom of the valve core, wherein the at least a core groove is formed along the outer circumference in a longitudinal direction of the valve core.

The at least a core groove may be at least five or more for rapid and smooth flow of coolant.

According to a suction check valve of the present invention, since although low-pressure coolant flows inside through a cap hole when an air-con compressor starts to operate, it can rapidly and smoothly flows outside a valve housing through a plurality of core grooves and a housing hole having a large cross-sectional area, it is possible to prevent vibration of a valve core and noise is not generated until the low-pressure coolant completely flows outside from the valve housing.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an air-con compressor equipped with a suction check valve.

FIGS. 2 and 3 are a perspective view and a cross-sectional view, respectively, for illustrating a suction check valve of a related art.

FIG. 4 is a development view of a valve housing for illustrating housing holes of the suction check valve of the related art.

FIGS. 5 and 6 are a perspective view and a cross-sectional view, respectively, for illustrating a suction check valve according to an exemplary embodiment of the present invention.

FIG. 7 is a development view of a valve housing for illustrating housing holes of the suction check valve according to an exemplary embodiment of the present invention.

FIG. 8 is a graph showing the result of measuring noise for the suction check valve of the related art and the suction check valve according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

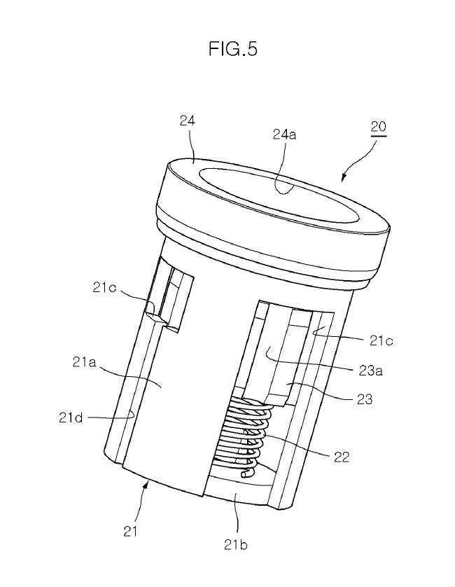

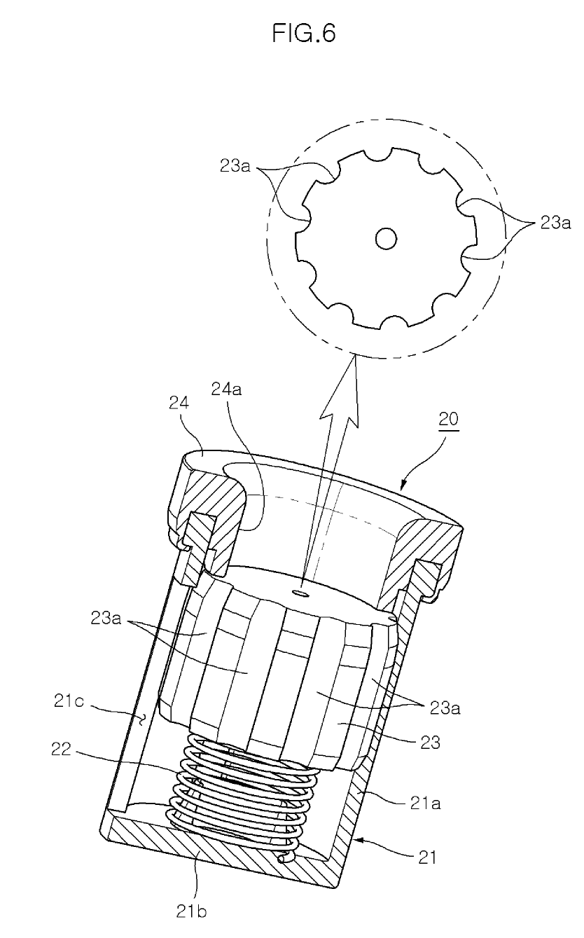

FIGS. 5 and 6 are a perspective view and a cross-sectional view of a suction check valve according to an embodiment of the present invention, respectively.

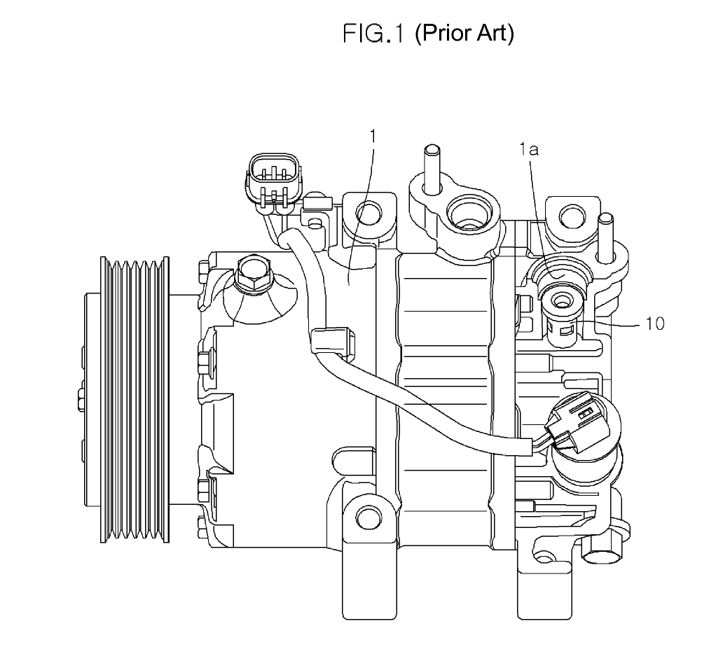

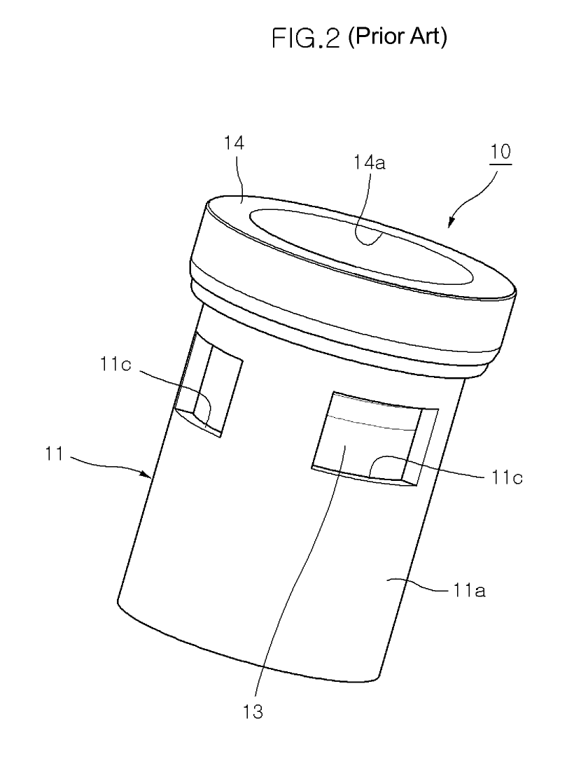

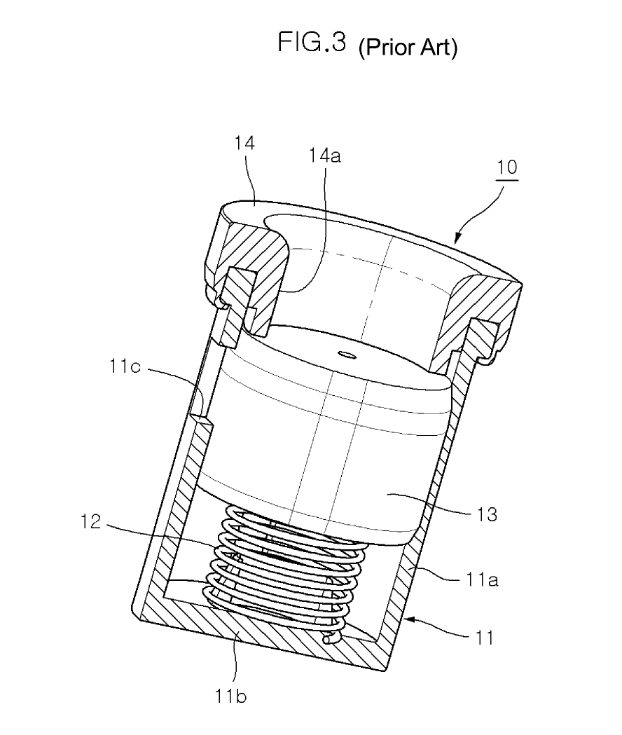

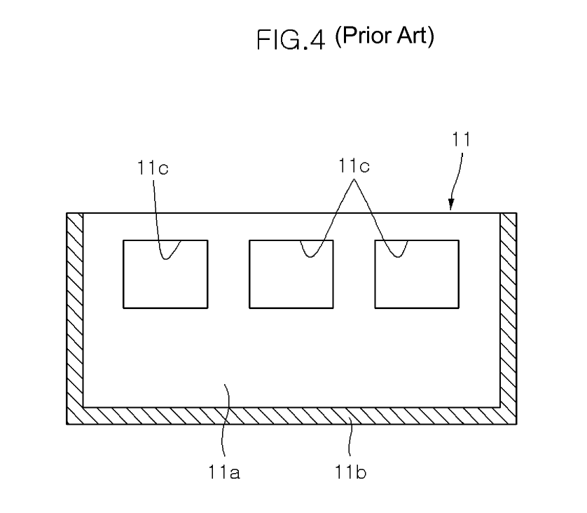

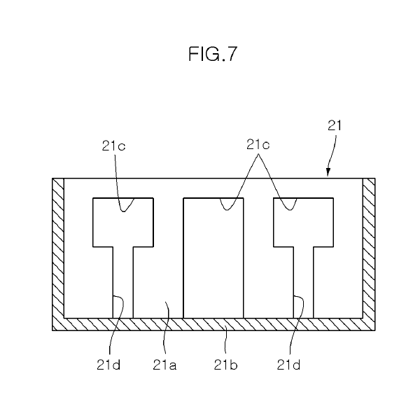

An air-con compressor 1 of an air-conditioning system, as shown in FIG. 1, has an intake port 1a for sucking gas-state coolant at low temperature and pressure discharged from an evaporator and intake port 1a, as shown in FIGS. 5 to 7, is equipped with suction check valve 20 according to an embodiment of the present invention.

Suction check valve 20 includes a valve housing 21 fixed in intake port 1a air-con compressor 1 and having a plurality of housing holes 21c, a valve core 23 elastically supported by a valve spring 22 in valve housing 21 to reciprocate in the longitudinal direction of valve housing 21 and having a plurality of core grooves 23a formed along the outer circumference, and a valve cap 24 connected to the upper end of valve housing 21 to prevent valve core 23 from separating from valve housing 21 and having a cap hole 24a connecting intake port 1a with valve housing 21.

In this configuration, valve housing 21 is composed of a cylinder 21a and a bottom 21b, and three housing holes 21c are formed from cylinder 21a to bottom 21b and circumferentially spaced at 120° in cylinder 21a.

Further, any one of housing holes 21c has a cross-sectional area different from the other housing holes 21c, and in the present embodiment, any one of housing holes 21c has a cross-sectional area larger that those of the other housing holes 21c.

Further, core grooves 23a are formed on the outer circumference of valve core 23 to connect the top with the bottom of valve core 23, and at least five core grooves 23a are formed for rapid and smooth flow of coolant.

The operation of an embodiment of the present invention is described hereafter.

In suction check valve 20 according to an embodiment of the present invention, as valve core 23 is moved down against the force of valve spring 22 by pressure of coolant discharged from the evaporator, cap hole 24a is connected with housing holes 21c, such that the coolant flows into a suction chamber of compressor 1.

Coolant at low initial pressure flows inside through cap holes 24a, when air-con compressor 1 converts from the OFF-state into the ON-state, that is it starts to operate.

As the coolant at low pressure flows inside, as described above, valve core 23 is moved down against the force of the valve spring 22 by the pressure of the coolant, but the displacement is very small for the low pressure of the coolant.

Accordingly, valve core 23 may be vibrated by confliction of the low pressure of the coolant and the force of the valve spring 22. However, since core grooves 23a are formed along the outer circumference of valve core 23 in the present embodiment, the low-pressure coolant flows outside through a gap between the lower end of cap hole 24a and the upper end of valve core 23 and also flows outside through the core grooves 23a.

Therefore, according to suction check valve 20 of the present embodiment, although the low-pressure coolant flows inside through cap hole 24a when air-con compressor 1 starts to operate, it flows outside through core grooves 23a, such that there is no confliction of the low pressure of the coolant and the force of valve spring 22 at valve core 23 which has occurred in the related art and valve core 23 correspondingly does not vibrate. As a result, noise is not generated until the low-pressure coolant completely flows outside through housing holes 21c.

Further, since any one of housing holes 21c has a cross-sectional area larger than those of the other holes in suction check valve 20 according to an embodiment of the present invention, the coolant in valve housing 21 can rapidly flows outside through the housing hole 21c having a large cross-sectional area.

In an exemplary embodiment of the present invention, one of the housing holes 21c may be formed at upper portion of the cylinder 21a such that the coolant in valve housing 21 can rapidly flow outside therethrough. In another exemplary embodiment of the present invention, a housing slot 21d may be formed to the housing hole 21c disposed at the upper portion of the cylinder 21a such that the coolant in valve housing 21 can flow outside therethrough while the high-pressure coolant flows inside through the cap hole 24a.

Therefore, since although low-pressure coolant flows into valve housing 21 through cap hole 24a when compressor 1 starts to operate, it rapidly flows outside valve housing 21 through the housing hole 21c having a large cross-sectional area, it is possible to considerably reduce the time that the low-pressure coolant takes to exist in valve housing 21, which significantly contribute to basically prevent noise from being generated.

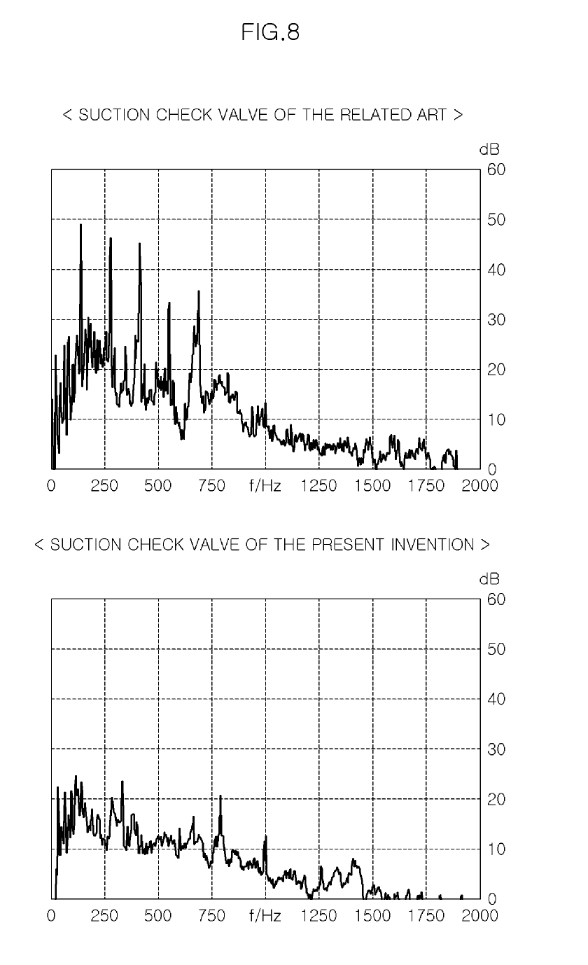

FIG. 8 is a graph showing a result of measuring noise for suction check valve 10 of the related art and suction check valve according to an embodiment of the present invention. It can be seen from the graph that noise was considerably reduced by about 30 dB in suction check valve 10 according to an embodiment of the present invention compared to suction check valve 100 of the related art, in the range of 100 Hz˜700 Hz.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A suction check valve of an air-con compressor of a vehicle, comprising:
a valve housing fixed in an intake port of the air-con compressor and having at least a housing hole;
a valve core elastically supported upwards by an elastic member in the valve housing to reciprocate in the longitudinal direction of the valve housing and having at least a core groove formed along outer circumference thereof; and
a valve cap connected to an upper end of the valve housing to prevent the valve core from separating from the valve housing and having a cap hole connected the intake port with the valve housing.

2. The suction check valve of the air-con compressor of the vehicle as defined in claim 1, wherein any one of the at least a core groove is always fluid-communicated with any one of the at least a housing hole.

3. The suction check valve of the air-con compressor of the vehicle as defined in claim 1, wherein:
the valve housing includes a cylinder portion to slidably receive the valve core therein and a bottom portion to support the elastic member,
the at least a housing hole is formed to the cylinder portion along a longitudinal direction thereof, and
at least one of the housing holes has a cross-sectional area different from the other housing holes.

4. The suction check valve of the air-con compressor of the vehicle as defined in claim 3, wherein the at least a housing hole is formed approximately at 120° from each other along the circumference of the cylinder portion.

5. The suction check valve of the air-con compressor of the vehicle as defined in claim 3, wherein at least one of the housing holes is larger in cross-sectional area than other housing holes.

6. The suction check valve of the air-con compressor of the vehicle as defined in claim 5, wherein the at least one of the housing holes that is larger in cross-sectional area than the other housing holes is formed at upper portion of the cylinder portion.

7. The suction check valve of the air-con compressor of the vehicle as defined in claim 6, wherein the at least one of the housing holes that is larger in cross-sectional area than the other housing holes and is formed at upper portion of the cylinder portion, is connected to a housing slot extending to the bottom portion of the valve housing along the cylinder portion.

8. The suction check valve of the air-con compressor of the vehicle as defined in claim 7, wherein a circumferential length of the at least one of the housing holes that is larger in cross-sectional area than the other housing holes and is formed at the upper portion of the cylinder portion, is larger than a circumferential length of the housing slot.

9. The suction check valve of the air-con compressor of the vehicle as defined in claim 1, wherein the at least a core groove is formed on the outer circumference of the valve core to connect the top with the bottom of the valve core.

10. The suction check valve of the air-con compressor of the vehicle as defined in claim 9, wherein the at least a core groove is formed along the outer circumference in a longitudinal direction of the valve core.

11. The suction check valve of the air-con compressor of the vehicle as defined in claim 10, wherein the at least a core groove is at least five or more for rapid and smooth flow of coolant.
